(19) United States
(12) Patent Application Publication
(10) Pub. No.: US 2009/0058884 A1
(43) Pub. Date: Mar. 5, 2009

(54) IMAGE DISPLAY DEVICE AND METHOD

(75) Inventors: XIAO-GUANG LI, Shenzhen City (CN); KUAN-HONG HSIEH, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/186,526

(22) Filed: Aug. 6, 2008

(30) Foreign Application Priority Data
Aug. 31, 2007 (CN) 200710076757.9

(51) Int. Cl. G09G 5/00

(52) U.S. Cl. 345/660

(57) ABSTRACT

An image display device and method are provided. The image playing device includes a display, a storage means, an information acquiring unit, and a comparing unit. The storage means stores images and related information related to the images. The information acquiring unit obtains an image resolution of an image to be displayed and a display resolution of the display, both of which are measured in pixels and are represented by a height resolution and a width resolution. The comparing unit compares the image resolution and the display resolution to determine whether the image fits the display. If so, the image is displayed full screen and the related information is displayed as a data stamp on the image. If not, the image is zoomed out to fit the width or height of the display screen or is displayed full size and the related information is displayed in a margin area.

### BACKGROUND

1. Technical Field

The present invention relates to an image display device and method for the same.

2. General Background

Image display devices, such as digital photo frames, are becoming widely used. Generally, a digital photo frame displays an image along with related information about the image, such as photographer of the image, date, time etc.

Images with resolutions within a predetermined range can be normally displayed. For example, if an image display device has a constant resolution of 800×600 pixels, images with resolutions within the constant resolution of the image display device can be full-screen or full-size displayed and the related information is displayed in a fixed information area.

However, in some image display devices, to allow for the fixed information area, images with resolutions out of the constant resolutions of the image display devices need to be resized, which may involve cropping the image, thus resulting in losing of some information of the image.

Accordingly, image display devices of this type can be still improved.

### SUMMARY

The invention relates to a device and method for displaying images and related information. The image display device includes a screen and a storage means for storing the images and related information. The image display device also includes an information acquiring module and a comparing module. The information acquiring module is used for obtaining a resolution of an image to be displayed, a display resolution and information related to the image. The comparing module compares the image resolution with the display resolution to determine whether the image resolution fits the screen. When the image resolution fits the screen, the image is displayed full screen and the related information is displayed as a data stamp on the image. When the image resolution does not fit the screen, the image is zoomed out to fit the width or height of the display screen or is displayed full size and a margin area is formed between the image and the display screen, the related information is displayed as a data stamp in the margin area.

Other features and advantages will be or become apparent to one with skill in the art upon examination of the accompanying drawings and detailed description. It is intended that all such additional systems, methods, features, and advantages be included within this description, be within the scope of the present invention, and be protected by the accompanying claims.

### BRIEF DESCRIPTION OF THE DRAWINGS

FIG. 1 is a block diagram of an image display device according to one embodiment of the present invention.

FIG. 2 is a schematic view showing an image displayed full screen in the image display device of FIG. 1.

FIG. 3 is a schematic view showing an image displayed horizontally offset in the image display device of FIG. 1.

FIG. 4 is another schematic view showing an image displayed horizontally offset in the image display device of FIG. 1.

FIG. 5 is another schematic view showing an image displayed horizontally offset in the image display device of FIG. 1.

FIG. 6 is a schematic view showing an image displayed vertically offset in the image display device of FIG. 1.

FIG. 7 is a flowchart of a method for displaying images according to one embodiment of the present invention.

### DETAILED DESCRIPTION OF THE EMBODIMENTS

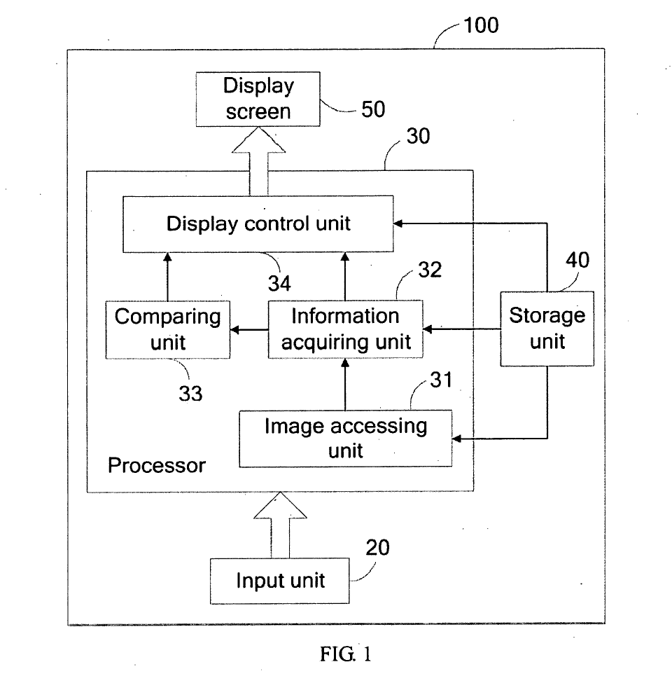

Referring to FIG. 1, an image display device 100 in accordance with one embodiment of the present invention is provided. The image display device 100, such as, but not limited to, a digital photo frame, is operable to display images. The image display device 100 includes an input unit 20, a processor 30, a storage unit 40, and a display screen 50.

The input unit 20 receives commands corresponding to various functions from a user and generates corresponding signals. Command functions may include for example, image selection, search, and display functions, etc.

The storage unit 40 can be any appropriate storage medium, such as a combination of read-only memory and random-access memory, for storing images and related information. The related information may include system information and/or information related to the images stored in the storage unit 40. The system information includes, but is not limited to, system date, time etc. The information related to the images includes, but is not limited to, photographers' name, image capture date and location, etc.

The processor 30, which interprets and executes instructions, includes an image accessing unit 31, an information acquiring unit 32, a comparing unit 33, and a display control unit 34. The image accessing unit 31, in response to a signal from the input unit 20, reads a corresponding image from the storage unit 40.

The information acquiring unit 32 obtains an image resolution of the image, a display resolution of the display screen 50, and related information of the image. In this embodiment, the image resolution and the display resolution are represented by “width×height” in pixels.

The comparing unit 33 compares a width resolution ratio (WR) and a height resolution ratio (HR) to determine whether the image resolution fits the display screen 50. WR is a ratio of the width resolution of the image to the width resolution of the display screen 50. HR is a ratio of the height resolution of the image to the height resolution of the display screen 50.

The display control unit 34 controls the display screen 50 to display the image. The manner the image is displayed is determined according to the magnitude relation between WR, HR, and 1, as described in the below table 1:

TABLE 1

| | Image | |
|---|---|---|
| | Resolution | |
| | Fitting The | Image Displaying |
| Magnitude Relation | Screen? | Manner |
| WR = HR ≧ 1 | Yes | Full Screen Display |
| WR ≦ 1, HR < 1; WR < 1, HR ≦ 1; | No | Full Size Display |
| WR > HR ≧ 1; WR ≧ 1 > HR; | No | Full Width Display |
| WR > 1 ≧ HR | | |
| HR > WR ≧ 1; HR ≧ 1 > WR; | No | Full Height Display |
| HR > 1 ≧ WR | | |

As shown in the table 1, when the image resolution does not fit the display screen 50, the image can be displayed full width of the display screen 50 (full width display) or displayed full height of the display screen 50 (full height display) or displayed at full size of the image (full size display). When the image resolution fits the display screen 50, the image is displayed full screen.

When the image resolution fits the display screen 50, the display control unit 34 controls the display screen 50 to display the related information corresponding with the image in the form of a stamp. The related information stamp is positioned on the image in a fixed area, such as a corner of the display screen 50 of the image display device 100. The related information stamp is substantially transparent, such that detailed viewing of the image is not affected.

When the image resolution does not fit the display screen 50, the image is zoomed out to fit the width or height of the display screen 50 or is full size displayed. However, no matter how the image is displayed, a margin area is formed between the image and the display screen 50.

When the image resolution does not fit the display screen 50, the display control unit 34 controls the display screen 50 to display the related information in the form of a stamp in the margin area. In one embodiment, the related information stamp includes a plurality of forms with different sizes. The related information stamp is displayed in a suitable form according to the space provided by the margin area. If the margin area has no enough space for any form of related information stamp, the related information stamp is displayed on the image and is substantially transparent.

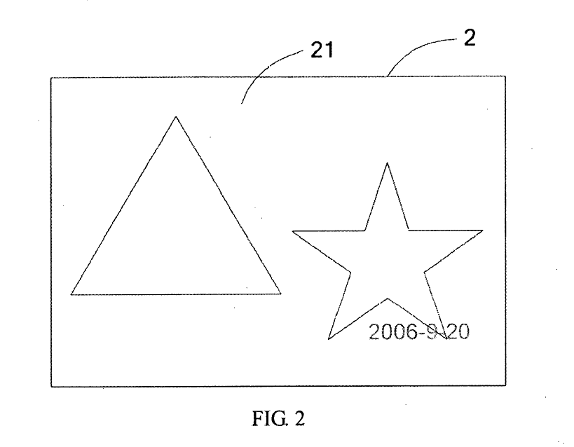

FIG. 2 depicts that an image 2 with a star and a triangle is full-screen displayed when image resolution of the image 2 fits the display screen 50. The related information of system date corresponding with the image is displayed at a corner of the display area 21 as a stamp on the image.

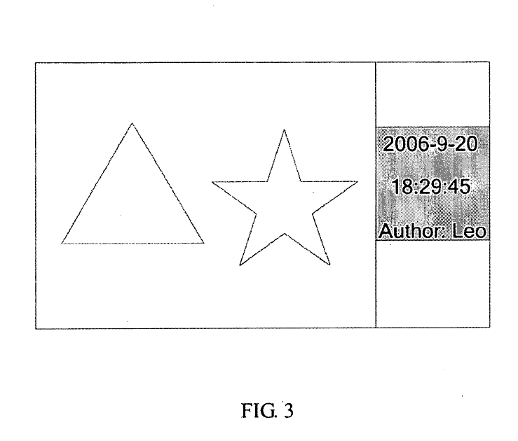

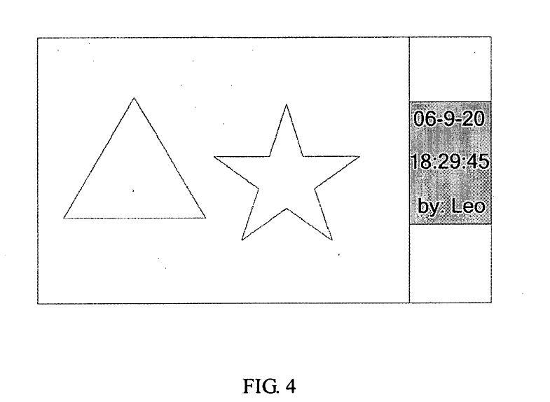

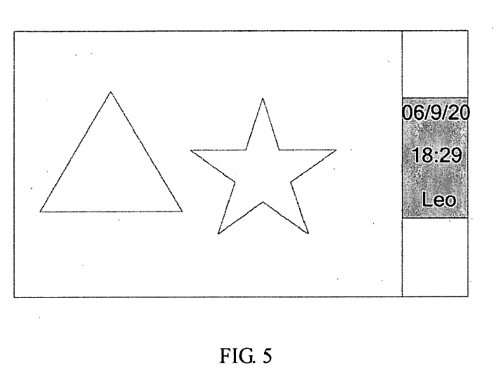

FIGS. 3, 4 and 5 depict that images with different image resolutions not fitting the display screen 50 are zoomed out to the full height of the display screen 50 and are displayed left offset. As illustrated, with the decreasing of the spaces provided by the margin areas, the related information stamps are displayed in different sizes and formats.

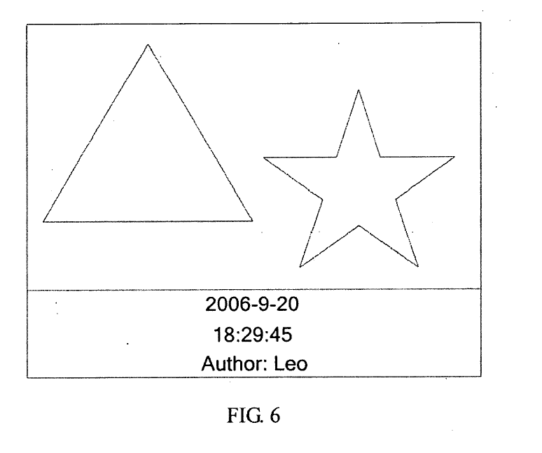

FIG. 6 depicts that an image with image resolution not fitting the display screen 50 is zoomed out to the full width of the display screen 50 and is displayed downward offset. The related information is displayed as a stamp in the margin area.

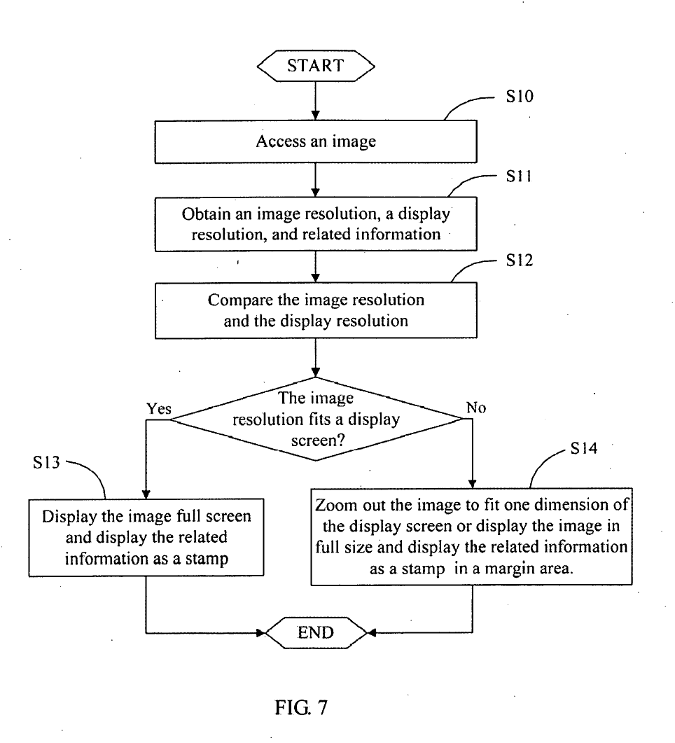

Referring to FIG. 7, an exemplary method of displaying images in accordance with one embodiment of the present invention is provided. In step S10, the image accessing unit 31 reads an image in response to signals from the input unit 20. In step S11, the information acquiring unit 32 obtains the image resolution of the image, the display resolution of the display screen 50, and the related information corresponding with the image. In step S12, the comparing unit 33 compares the image resolution and the display resolution to determine whether the image resolution fits the display screen 50, if the comparing result is true, the flow goes to the step S13 in which the display control unit 34 controls the display screen 50 to display the image full screen and display the related information as a stamp on the image. If the comparing result is false, the flow goes to step S14 in which the display control unit 34 controls to zoom out the image to fit the width or height of the display screen 50 or display the image full size and display the related information as a stamp in the margin area.

What is claimed is:

1. An image display device comprising:
a display screen;
a storage means capable of storing images and their related information;
an information acquiring module capable of obtaining a display resolution of the display screen, the image resolution of an image to be displayed, and related information of the image, the display resolution and the image resolution being measured in pixels and represented by a height resolution and a width resolution; and
a comparing module for comparing the image resolution and the display resolution to determine whether the image resolution fits the display screen;
wherein, the image is displayed full screen and the related information is displayed as a data stamp on the image if the image resolution fits the display screen; otherwise, the image is zoomed out to fit the width or height of the display screen, or is displayed full size and a margin area is formed between the image and the display screen, the related information is displayed as a data stamp in the margin area.

2. The image display device according to claim 1, wherein when the image resolution does not fits the display screen and at least one of the height resolution or width resolution of the image is greater than that of the display screen, the image is zoomed out and displayed full width or full height of the display screen.

3. The image display device according to claim 1, wherein when both of the height resolution and the width resolution of the image resolution are smaller than that of the display resolution, the image is displayed full size.

4. The image display device according to claim 1, wherein the data stamp has a plurality of forms with different sizes for fitting different sizes of the margin areas.

5. The image display device according to claim 4, wherein if a data stamp does not fit a margin area in any form, the data stamp is displayed on the image.

6. A method for displaying images in a display, comprising:
accessing an image to be displayed;
obtaining an image resolution of the image, a display resolution of the display, and related information related to the image;
comparing the image resolution and the display resolution to determine whether the image resolution fits a display screen of the image display device;
if the image resolution fits the display screen, displaying the image full screen and display the related information as a data stamp on the image;
if the image resolution does not fit the screen, zooming out the image to fit the width or height of the display screen, or displaying the image full size, and displaying the related information as a data stamp in a margin area formed between the image and the display screen.

7. The method for displaying images in a display according to claim 6, wherein the data stamp has a plurality of forms with different sizes for fitting different sizes of the margin areas.

8. The method for displaying images in a display according to claim 7, if a data stamp does not fit a margin area in any form, the data stamp is displayed on the image.
